(19) United States
(12) Patent Application Publication
(10) Pub. No.: US 2013/0141511 A1
(43) Pub. Date: Jun. 6, 2013

(54) IMAGE FORMING APPARATUS

(71) Applicant: Canon Kabushiki Kaisha, Tokyo (JP)

(72) Inventors: Hideaki Hasegawa, Suntou-gun (JP); Yasunari Watanabe, Suntou-gun (JP); Masaru Shimura, Yokohama-shi (JP); Shinsuke Kobayashi, Yokohama-shi (JP); Hideo Nanataki, Yokohama-shi (JP); Shinji Katagiri, Yokohama-shi (JP); Kiyoto Toyoizumi, Susono-shi (JP)

(73) Assignee: CANON KABUSHIKI KAISHA, Tokyo (JP)

(21) Appl. No.: 13/687,272

(22) Filed: Nov. 28, 2012

(30) Foreign Application Priority Data
Dec. 2, 2011 (JP) 2011-264879

(51) Int. Cl. B41J 2/435

(52) U.S. Cl. CPC G03G 15/043; G03G 15/22
USPC 347/224

(57) ABSTRACT

An image forming apparatus includes a photosensitive member, a charging unit configured to charge the photosensitive member, an exposure unit configured to expose the charged photosensitive member with first laser power to generate a non-image portion potential in a non-image portion of the photosensitive member and with second laser power different from the first laser power to generate an image portion potential in an image portion of the photosensitive member, a development unit configured to form a developer image by applying a developer to a portion of the image portion potential, a control unit configured to control the laser power of the exposure unit, and a storage unit configured to store information about the photosensitive member obtained when the photosensitive member is brand-new. The control unit changes an output of the first laser power according to the information about the photosensitive member stored in the storage unit.

### BACKGROUND OF THE INVENTION

1. Field of the Invention

The present disclosure generally relates to an image forming apparatus such as a copying machine or a printer of an electrophotographic type.

2. Description of the Related Art

Conventionally, in some electrophotographic image forming apparatuses, a contact charging device, which employs a method in which a voltage is applied to a charging member abutting on a photosensitive member to charge the photosensitive member, has been put to practical use, because of its advantages of lower ozone use and lower power consumption. In particular, a device of the roller charging type using a charging roller as a charging member has been in wide use because of its excellent charging stability.

In the contact charging device of the roller charging type, when a certain level of voltage (charging start voltage Vth) is applied to the charging roller, a surface potential of the photosensitive member starts to rise. Thereafter, the photosensitive member surface potential linearly increases by a gradient of 1 with respect to the applied voltage. This indicates that, to acquire a photosensitive member surface potential (Vd) necessary for electrophotography, a direct current (DC) voltage of Vd+Vth is to be applied.

In the DC charging system, as a method for improving uniformity of the surface potential of the photosensitive member, the following conventional technology has been offered. Specifically, Japanese Patent Application Laid-Open No. 8-171260 discusses a method for controlling a potential. According to this method, first, a primary charging device charges the photosensitive member to a potential equal to or higher than a non-image portion potential (Vd) necessary for forming an image. Then, an exposure device (post-exposure device), which is disposed in a position after primary charging and before development, emits weak light to expose the photosensitive member potential and to attenuate (lower) the surface potential, so that a target non-image portion potential (Vd) can be attained.

In the DC charging system, the charging start voltage Vth changes depending on a photosensitive layer film thickness of the photosensitive member. Consequently, when the abrasion of the photosensitive member causes a reduction of the photosensitive member film thickness, the non-image portion potential (Vd) rises. Thus, according to the method discussed in Japanese Patent Application Laid-Open No. 8-171260, the photosensitive member film thickness is measured from a value of charge current flowing when an alternating current (AC) voltage is applied to the charging roller to charge the photosensitive member surface. A light amount for exposing the non-image portion is corrected based on the measured photosensitive member film thickness to attain the target non-image portion potential (Vd).

Japanese Patent Application Laid-Open No. 2002-296853 discusses a method for making a constant potential setting of the photosensitive member by calculating (computing) the photosensitive member film thickness based on information about the number of passing sheets, a rotational speed of the photosensitive member, or a charging voltage application period, to control an exposure amount according to the photosensitive member film thickness. According to this method, a maximum value and a minimum value of the exposure amount applied to the photosensitive member are changed based on the calculated photosensitive member film thickness. Specifically, a maximum light amount for generating an image portion potential (Vl) and a minimum light amount for generating a non-image portion potential (Vd) are changed.

However, in order to attain the stable image portion potential (Vl) and the stable non-image portion potential (Vd) over a long period of use of the photosensitive member, there has been room for improvement.

Specifically, when the non-image portion potential (Vd) is generated by executing non-image portion exposure with respect to the primary charge potential, the non-image portion exposure amount is required to be controlled according to a state of the photosensitive member film thickness. As discussed in Japanese Patent Application Laid-Open No. 8-171260, when the method for controlling the exposure amount of the non-image portion by detecting a charge current value flowing during primary charging of the photosensitive member surface is used, a detection circuit is required be added to detect a charge current value for each of photosensitive members. Thus, when the method is applied to a color image forming apparatus using a plurality of photosensitive members, there can be disadvantageous in miniaturization of the apparatus and in reduction of costs. Further, to detect the charge current value, at least rotational driving of the photosensitive member and charging voltage application are necessary. This may affect a life of the photosensitive member.

As discussed in Japanese Patent Application Laid-Open No. 2002-296853, when the method for controlling the exposure amount of the non-image portion according to a change amount of the photosensitive member film thickness calculated from the photosensitive member rotational speed is used, it is difficult to correct potential fluctuation caused by variations of film thickness or sensitivity unique to each photosensitive member (obtained when the photosensitive member is brand-new). Thus, there has been room for improvement to attain a stable target photosensitive member potential.

### SUMMARY OF THE INVENTION

The present disclosure is directed to an image forming apparatus capable of correcting potential fluctuation of a photosensitive member caused by variations of film thickness or sensitivity unique to the photosensitive member (obtained when the photosensitive member is brand-new) with a simple configuration.

According to an aspect of the present disclosure, an image forming apparatus configured to form an image on a recording medium includes a photosensitive member, a charging unit configured to charge the photosensitive member, an exposure unit configured to expose the photosensitive member charged by the charging unit with first laser power to generate a non-image portion potential in a non-image portion of the photosensitive member and with second laser power different from the first laser power to generate an image portion potential in an image portion of the photosensitive member, a development unit configured to form a developer image by applying a developer to a portion of the image portion potential, a control unit configured to control the laser power of the exposure unit, and a storage unit configured to store information about the photosensitive member obtained when the photosensitive member is brand-new. The control unit is configured to change an output of the first laser power according to the information about the photosensitive member obtained when the photosensitive member is brand-new, stored in the storage unit.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles of the invention.

FIG. 1 is a flowchart illustrating laser power control according to a first exemplary embodiment.

FIG. 2 is a schematic sectional view illustrating an image forming apparatus according to the first exemplary embodiment.

FIG. 3A is a graph illustrating an E-V curve in a photosensitive drum according to the first exemplary embodiment, and FIG. 3B is a diagram illustrating a potential setting according to the first exemplary embodiment.

FIG. 4 is a schematic sectional view illustrating power source wiring according to the first exemplary embodiment.

FIG. 5A is a graph illustrating a relationship between a photosensitive layer film thickness and E-V curves in the photosensitive drum according to the first exemplary embodiment, and FIG. 5B is a graph illustrating changes of primary charge potentials and E-V curves in response to changes in photosensitive layer film thickness according to the first exemplary embodiment.

FIG. 6A is a diagram illustrating a potential change according to a conventional example, and FIG. 6B is a diagram illustrating a potential change according to the first exemplary embodiment.

FIG. 7A is a diagram illustrating a method for calculating laser power E1 according to the first exemplary embodiment, and FIG. 7B is a diagram illustrating a method for calculating laser power E2 according to the first exemplary embodiment.

FIG. 8 is a schematic diagram illustrating a power source circuit for outputting a charging bias voltage and a developing bias voltage according to the first exemplary embodiment.

FIG. 9 is a flowchart illustrating laser power control according to a second exemplary embodiment.

FIG. 10A is a graph illustrating a relationship between photosensitive layer sensitivity and the E-V curve in the photosensitive drum according to the first exemplary embodiment, and FIG. 10B is a graph illustrating a relationship between exposure history and E-V curves in a photosensitive drum according to the second exemplary embodiment

FIG. 11 is a bock diagram illustrating a control system according to the first exemplary embodiment.

### DESCRIPTION OF THE EMBODIMENTS

Various exemplary embodiments, features, and aspects of the disclosure will be described in detail below with reference to the drawings.

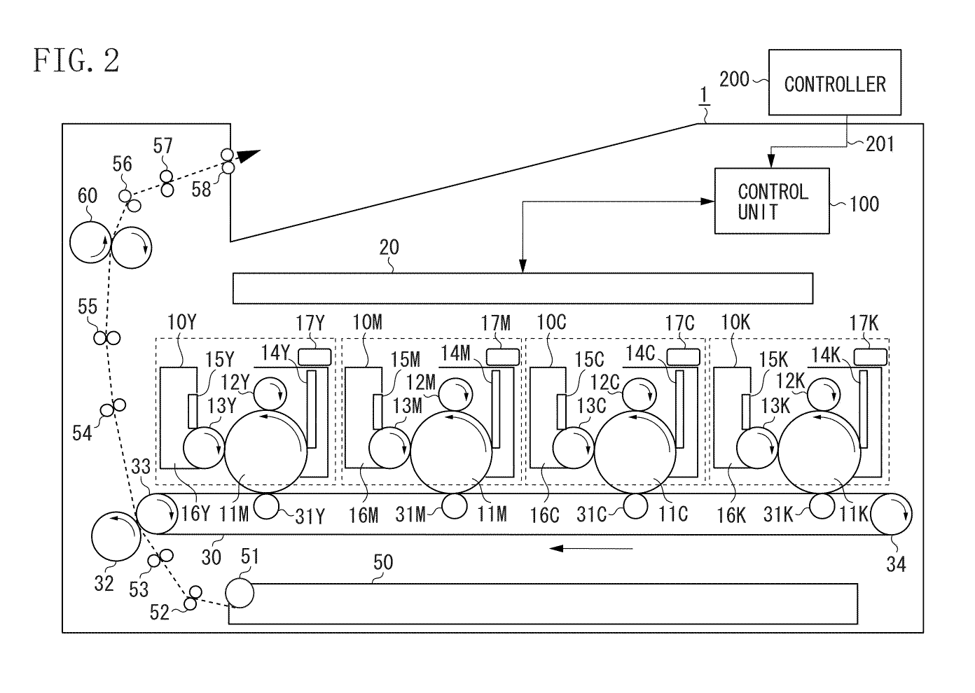

FIG. 2 is a schematic sectional view illustrating an image forming apparatus according to a first exemplary embodiment.

In FIG. 2, an image forming apparatus 1 is a laser beam printer that uses an electrophotographic process. The image forming apparatus 1 forms an image corresponding to image data (electric image information) input from a printer controller (external host apparatus) 200 connected to a printer control unit 100 via an interface 201 on a sheet P as a recording medium to output an image formed product. The control unit 100, which is configured to control an operation of the image forming apparatus, transfers various electric information signals to and from the printer controller 200. The control unit 100 also controls processing of electric information signals input from various process devices and sensors, processing of command signals to various process devices, a predetermined initial sequence, and a predetermined image forming sequence. The printer controller 200 includes a host computer, a network, an image reader, or a facsimile. A recording material P includes recording paper, an overhead projector (OHP) sheet, a postcard, an envelope, or a label.

The image forming apparatus 1 illustrated in FIG. 2 is of a tandem type in which four image forming units (process cartridges) 10Y, 10M, 10C, and 10K are arranged in parallel at fixed intervals in a lateral direction (roughly in a horizontal direction). In each of the process cartridges 10Y, 10M, 10C, and 10K, a photosensitive drum 11 as an image bearing member, a charging roller 12, a developing roller 13, a developing blade 15, and a drum cleaner 14 are integrally formed. The charging roller 12 uniformly charges the surface of the photosensitive drum 11 with a predetermined potential. The developing roller 13 bears and carries nonmagnetic one-component toner (with minus charge characteristics), and develops an electrostatic latent image formed on the photosensitive drum 11 into a developer image. The developing blade 15 makes a toner layer on the developing roller uniform. The drum cleaner 14 cleans the surface of the photosensitive drum 11 after transfer. The photosensitive drum 11 is driven to rotate at a surface moving speed of 120 (mm/sec.) in an illustrated arrow direction by a driving unit (not illustrated). The photosensitive drum 11 is formed by sequentially stacking a charge generation layer, a charge transport layer, and a surface layer on an aluminum tube. In the present exemplary embodiment, the charge generation layer, the charge transport layer, and the surface layer will be collectively described as a photosensitive layer.

The process cartridges 10Y, 10M, 10C, and 10K are configured roughly similarly except for toner housed in a development container 16. The process cartridges 10Y, 10M, 10C, and 10K are respectively used for forming toner images of yellow (Y), magenta (M), cyan (C), and black (K).

The process cartridges 10Y, 10M, 10C, and 10K are configured to be detachably attached to a body of the image forming apparatus 1. For example, when toner in a developing device 13 is consumed, each of the process cartridges 10Y, 10M, 10C, and 10K is configured to be replaceable.

Further, for each of the process cartridges 10Y, 10M, 10C, and 10K, a memory 17 is provided as a storage unit. As the memory 17, for example, a contact nonvolatile memory, a contactless nonvolatile memory, or a volatile memory having a power source can be arbitrarily used. In the present exemplary embodiment, the contactless nonvolatile memory 17 is mounted as a storage unit on the process cartridge. The contactless nonvolatile memory 17 includes an antenna as a memory side information transmission unit (not illustrated), and can read and write information by communicating with the control unit 100 of the body side of the image forming apparatus 1 wirelessly. Specifically, the control unit 100 includes an information transmission unit of the apparatus body, and has a function of reading and writing information from or in the memory 17. The memory 7 stores information about a photosensitive drum obtained when the photosensitive member is brand-new. Examples are a photosensitive layer film thickness (initial thickness of the photosensitive layer film) and sensitivity (initial sensitivity). Such information is stored at the time of manufacturing. Further, information about changes of the photosensitive drum through use thereof (information about change amounts of the photosensitive layer film thickness or the sensitivity) can be written or read as needed.

The developing roller 13, which is a development unit including a core metal and an elastic conductive layer formed concentrically and integrally around the core metal, is disposed almost in parallel to the photosensitive drum 11. The developing blade 15 made of a steel use stainless (SUS) sheet metal has a free end abutting on the developing roller 13 by a predetermined pressing force. The developing roller 13 bears and carries toner charged to negative polarity by friction to a development position facing the photosensitive drum. The developing roller 13 can be in contact with or be separated from the photosensitive drum 11 by a contacting/separating mechanism (not illustrated). During an image forming process, the developing roller 13 abuts on the photosensitive drum 11, and a DC bias voltage of about −300 V as a developing bias voltage is applied to the core metal of the developing roller 13.

The image forming apparatus 1 according to the present exemplary embodiment includes a laser exposure unit 20 configured as an exposure system to expose the photosensitive drum 11 disposed in each of the process cartridges 10Y, 10M, 10C, and 10K. The laser exposure unit 20 receives, from the control unit 100, a time-series electric digital pixel signal of processing image information input from the printer controller 200 via the interface 201. The laser exposure unit 20 includes a laser output unit for outputting a laser beam modulated according to the input time-series electric digital pixel signal, a rotational polygon mirror, a fθ lens, and a reflection mirror, and executes main scanning exposure to the surface of the photosensitive drum 11 with a laser beam L. Through this main scanning exposure and sub-scanning by rotation of the photosensitive drum 11, an electrostatic latent image corresponding to the image information is formed.

The charging roller 12, which is a contact charging unit including a core metal and an elastic conductive layer formed concentrically and integrally around the core metal, is disposed almost in parallel to the photosensitive drum 11, and abuts on the photosensitive drum 11 by a predetermined pressing force against elasticity of the elastic conductive layer. Both ends of the core metal are rotatably bearing-supported, and the charging roller 12 is driven to rotate with the photosensitive drum 11. In the present exemplary embodiment, a charging bias voltage is applied to the core metal of the charging roller 12.

Further, the image forming apparatus 1 according to the present exemplary embodiment includes an intermediate transfer belt 30 configured as a second image bearer to abut on the photosensitive drum 11 of each of the process cartridges 10Y, 10M, 10C, and 10K. The intermediate transfer belt 30 uses an endless resin film having an electric resistance value (volume resistivity) of 10¹¹ (Ω·cm) to 10¹⁶ (Ω·cm) and a thickness of 100 μm to 200 μm. As a material for the intermediate transfer belt 30, polyvinylidene fluoride (Pvdf), nylon, polyethylene terephthalate (PET), or polycarbonate (PC) can be used. The intermediate transfer belt 30 is stretched by the driving roller 34 and a secondary transfer counter roller 33, and cyclically driven at a process speed by rotating the driving roller 34 by a motor (not illustrated). A primary transfer roller 31 is formed in a roller shape having an elastic conductive layer on an axis, arranged almost in parallel to each photosensitive drum 11, and abuts on the photosensitive drum 11 by a predetermined pressing force via the intermediate transfer belt 30. ADC bias voltage of positive polarity is applied to the axis of the primary transfer roller 31 to form a transfer electric field.

Toner images with respective colors developed on the photosensitive drums 11 are conveyed to primary transfer positions by further rotating the photosensitive drums 11 in an arrow direction, and primary-transferred sequentially on the intermediate transfer belt 30 by primary transfer electric fields formed between the primary transfer rollers and the photosensitive drums 11. At this time, four-color images are sequentially transferred to the intermediate transfer belt 30 in a superimposed manner, and thus positions of the four color tonner images correspond with each other. Primary transfer residual toner on the photosensitive drum 11 is cleaned by the drum cleaner 14.

To constantly carry out the primary transfer step with satisfactory conditions of high transfer efficiency and a low re-transfer rate, a positive polarity bias applied from a primary transfer bias power source 71 must always be controlled to be an optimal value, taking into consideration an environment and component characteristics. This control is executed by a control unit (not illustrated).

The image forming apparatus 1 according to the present exemplary embodiment includes a sheet cassette 50, a pickup roller 51, a conveyance roller 52, and a registration roller 53 arranged on a sheet feeding side to constitute a sheet conveyance system. The sheet cassette 50 stores the sheet P. The pickup roller 51 takes out the sheet P as a recording material stored in the sheet cassette 50 at predetermined timing, and conveys the sheet P. The conveyance roller 52 conveys the sheet P delivered by the pickup roller 51. The registration roller 53 feeds the sheet P to a secondary transfer position according to an image forming operation.

After the four-color toner images have been primary-transferred to the intermediate transfer belt 30, the sheet P is conveyed from the registration roller 53 portion in synchronization with rotation of the intermediate transfer belt 30. Then, a secondary transfer roller 32 similar in configuration to the primary transfer roller 31 abuts on the intermediate transfer belt 30 via the sheet P. By using a secondary transfer counter roller 33 as a counter electrode, a positive polarity bias is applied to the secondary transfer roller 32 from a secondary transfer bias power source 702, and the four-color toner images on the intermediate transfer belt 30 are secondary-transferred collectively to the sheet P. Positive polarity charges are applied to secondary transfer residual toner by bias application of a charging brush (not illustrated) abutted on the intermediate transfer belt 30. Thus, the secondary transfer residual toner is transferred to the photosensitive drum 11 side at the primary transfer position during the image forming process, and collected to be recovered.

The sheet P to which the four-color toner images have been transferred is conveyed to a conventionally known fixing device 60 by conveyance rollers 54 and 55, and toner images unfixed onto the sheet P are subjected to fixing by heat and pressure to be fixed onto the sheet P. Then, the sheet P is conveyed to a discharge roller 58 by conveyance rollers 56 and 57, and discharged as a color-image-formed product from a discharge port to a discharge tray on the upper surface of the apparatus body by the discharge roller 58.

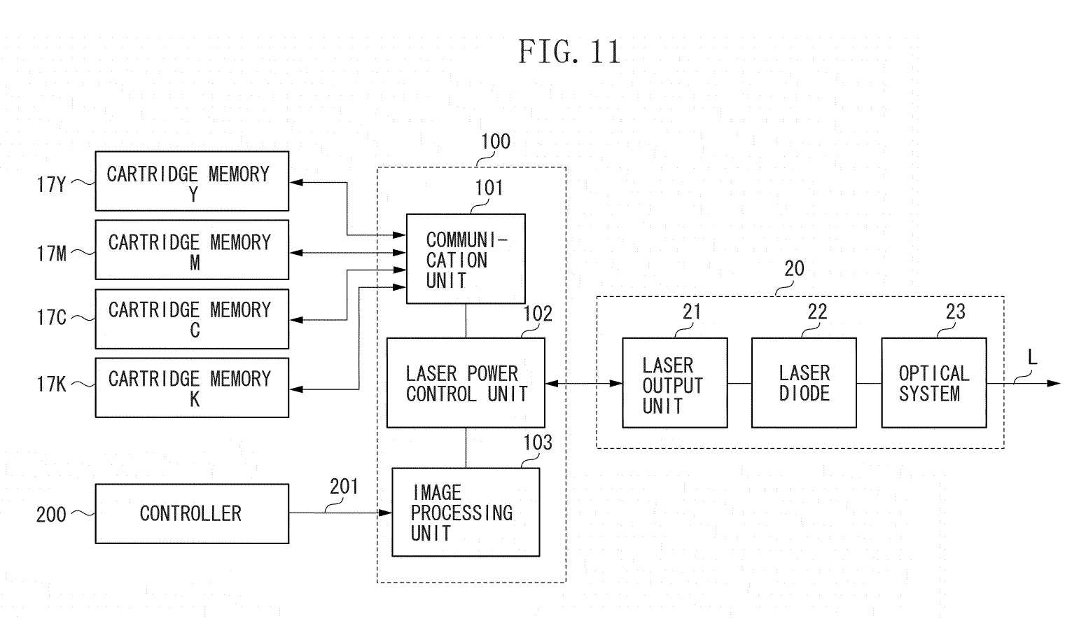

Referring to FIG. 11, a laser exposure unit according to the present exemplary embodiment will be described.

The laser exposure unit 20 according to the present exemplary embodiment is configured to switch and output values of two output levels, namely, first laser power (E1) and second laser power (E2) as laser outputs in exposing the surface of the photosensitive drum. In other words, the control unit 100 includes a laser power control unit 102 for individually controlling each of laser power E1 and E2. FIG. 11 is a block diagram illustrating a laser power control system. An image signal transmitted from the printer controller 200 is a multivalued signal (0 to 255) having a depth direction of 8 bits=256 gradations. When the signal is 0, a laser beam is to be off, and completely on (completely lit) when the signal is 255. The laser beam has, when the signal is between 1 and 254, an intermediate value therebetween. In the present exemplary embodiment, the signal is converted into a serial time-series digital signal by an image processing unit 103, and controlled to be 256 stages by using area coverage modulation with a 4×4 dither matrix and laser pulse width modulation with the control of laser emitting time of each dot pulse in 600 dots/inch. A communication unit 101 reads information about the photosensitive drum film thickness and sensitivity stored in each of process cartridges 17Y, 17M, 17C, and 17K. The laser power control unit 102 transmits a laser power signal, which is selected according to the condition of the photosensitive drum in each process cartridge, and an image data signal for each process cartridge to the laser exposure unit 20. A laser power output unit 21 switches laser power according to the selected signal input from the laser power control unit 102, and causes a laser diode 22 to emit light. The light passes through a correction optical system 23 including a polygon mirror and is applied as laser scanning light L to the photosensitive drum 11.

In the present exemplary embodiment, the laser power control unit 102 individually controls the first laser power (E1) and the second laser power (E2) for the respective process cartridges. The first laser power (E1) generates a dark portion potential (non-image portion potential Vd) in a non-image region. The second laser power (E2) generates a bright portion potential (image portion potential Vl) in an image region. In the present exemplary embodiment, during the image forming process, a weak laser beam is emitted with predetermined bias current supplied to the laser diode 22, which is set as the first laser power (E1). A current value is added and supplied for an image information portion, which is set as the second laser power (E2). The laser power control unit 102 controls the laser power E1 and the laser power E2 by making a current amount supplied to the laser diode 22 variable based on photosensitive drum surface potential control described below.

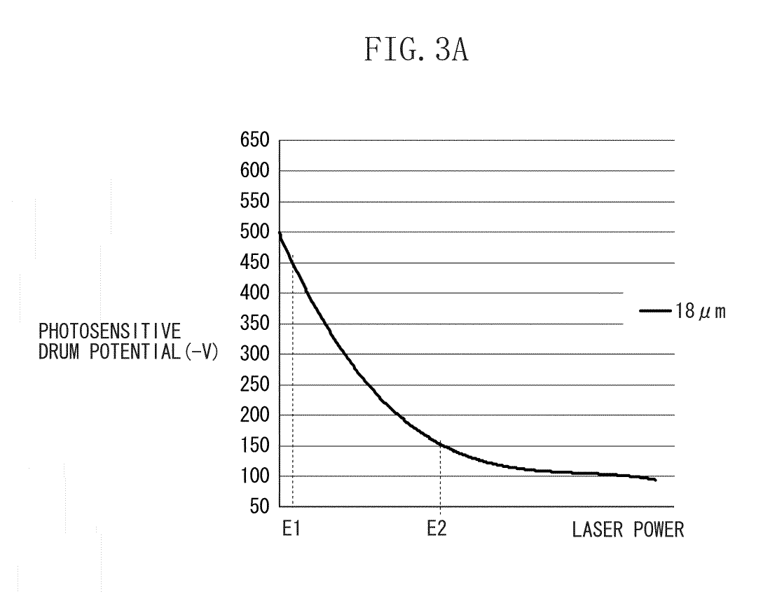

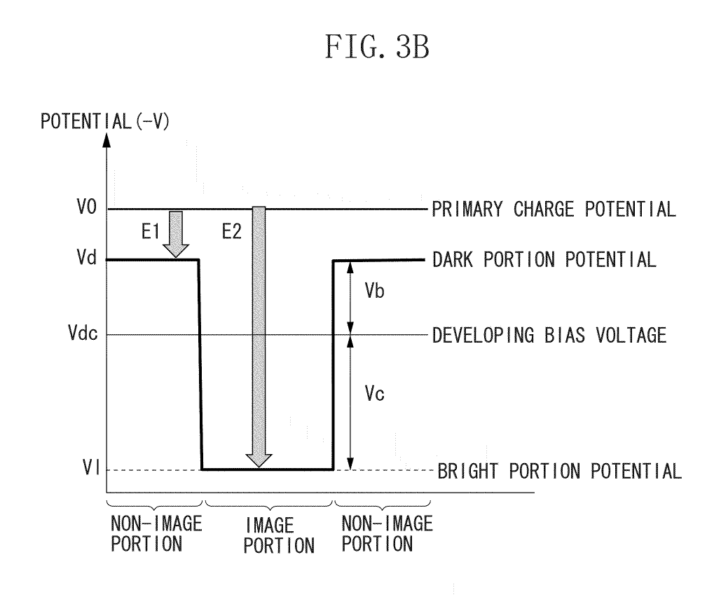

Referring to FIGS. 3A and 3B, a latent image setting according to the present exemplary embodiment will be described. The photosensitive drum 11 according to the present exemplary embodiment includes an aluminum cylindrical base and an organic photo conductor (OPC) photosensitive layer to cover its surface.

FIG. 3A illustrates a relationship between surface potential and exposure laser power (hereinafter, an E-V curve) when the photosensitive layer 11 having an initial photosensitive layer film thickness of 18 (μm) is exposed by predetermined laser power. The photosensitive drum 11 has been charged to −500 Vas a primary charge potential (V0) by applying a DC voltage of about −1040 (V) to the charging roller 12. The horizontal axis of the graph indicates exposure laser power E (μJ/cm²) received by the photosensitive drum surface. The laser exposure unit 20 exposes the image portion of the photosensitive drum 11 by the second laser power E2 (μJ/cm2) to generate a bright portion potential (Vl) of about 150 V. Simultaneously, the laser exposure unit 20 exposes a non-image information portion (background) by the first laser power E1 (μJ/cm2) to generate a dark portion potential (Vd) of about 450 V. A DC bias voltage of about −300 (V) is applied to the developing roller. Thus, negative charge toner conveyed to the development position adheres to a portion of the bright portion potential (Vl) because of potential contrast between the bright portion potential (Vl) and the developing bias voltage (Vdc) on the photosensitive drum 11, and an electrostatic latent image is reversely developed as a toner image.

The image forming apparatus 1 according to the present exemplary embodiment uses a reversal development method for charging the photosensitive drum 11 with negative polarity (minus) charges by the charging roller 12 and executing development with negative polarity (minus) charged toner. Thus, a region exposed by the second laser power E2 (μJ/cm²) becomes an image portion, while a region exposed by the first laser power E1 (μJ/cm²) becomes a white portion (background).

FIG. 3B illustrates a potential setting. A primary charge potential (V0) is a potential of the photosensitive drum 11 charged by the charging roller. Development contrast (Vc), which is a difference between a bright portion potential (Vl) and a developing bias voltage (Vdc) , is a factor for setting an image density and gradation of the image portion. More specifically, when the development contrast (Vc) is small, neither a sufficient image density nor gradation can be acquired. Accordingly, a predetermined value of the development contrast (Vc) must be secured. In the present exemplary embodiment, development contrast Vc is set to 150 (V). Further, white portion contrast (vb), which is a difference between the developing bias voltage (Vdc) and the dark portion potential (Vd) is a factor for determining a fogging (background staining) amount of the white portion. More specifically, when the white portion contrast (Vb) increases more than a predetermined value, reversely-charged toner (plus-charged toner) adheres to the white portion to become a fog, thus causing image staining or in-machine contamination. On the other hand, when the white portion contrast (Vb) decreases below the predetermined value, normally-charged toner (minus-charged toner) is developed on the white portion, thus causing fogging. Consequently, the white portion contrast (Vb) must be set within a predetermined range. In the present exemplary embodiment, white portion contrast Vb is set to 150 (V).

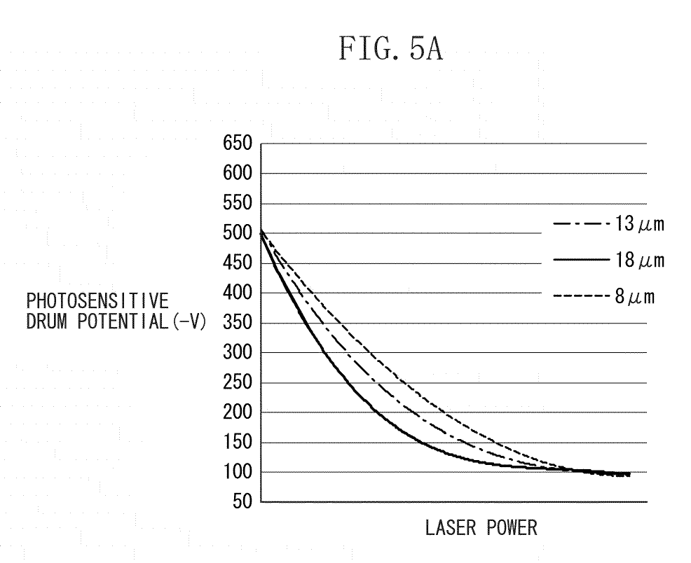

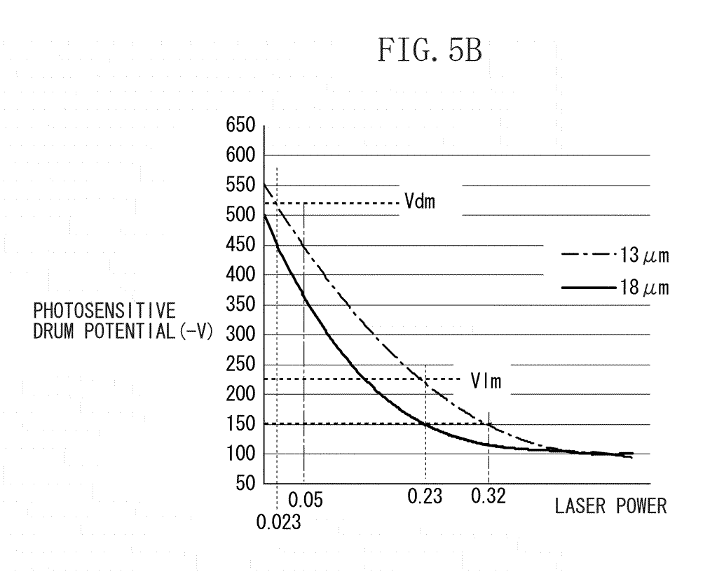

Next, referring to FIGS. 5A, 5B, 6A, and 10A, change characteristics of the E-V curve of the photosensitive drum will be described.

The photosensitive layer on the surface of the photosensitive drum 11 is subjected to discharging repeatedly with a printing operation, and the surface is abraded due to friction with the cleaning blade 14 or the developing roller 13. Consequently, the film thickness of the photosensitive layer decreases to cause a change in surface potential characteristics. FIG. 5A illustrates E-V curves when primary charge potentials are uniformed by adjusting charging bias voltages of the photosensitive drums having different film thicknesses. Film thickness reduction is accompanied by an increase of a surface charge density, thereby reducing inclination of the E-V curve. In other words, the photosensitive drum potential varies depending on the film thickness change of the photosensitive drum with time and depending on a photosensitive layer film thickness (initial film thickness) at the time of manufacturing.

When a charging bias output value is fixed to a predetermined value, the primary charge potential increases as the photosensitive layer film thickness changes. This is because an increase of capacitance is accompanied by reduction of a discharging start voltage between the charging roller and the photosensitive drum.

FIG. 5B illustrates E-V curves when a charging voltage is fixed to a predetermined value and the photosensitive drums having different photosensitive layer film thicknesses are charged. Specifically, FIG. 5B illustrates E-V curves when an output value of a charging bias voltage is fixed to about −1040 (V) and a photosensitive drum having a photosensitive layer film thickness of 18 (μm) and a photosensitive drum having a photosensitive layer film thickness of 13 (μm) are charged. A change in photosensitive layer film thickness causes an increase of the primary charge potential and a change in inclination of the E-V curve. In the case of the photosensitive layer film thickness of 18 (μm), laser exposure output values enabling acquisition of desired dark portion and bright portion potentials (Vd and Vl) are respectively E1=0.023 ((μJ/cm²) and E2=0.23 ((μJ/cm²). In this case, when print testing is conducted without changing the charging voltage and the laser exposure output value until a film thickness of the photosensitive layer becomes 13 (μm), both the dark portion potential (Vd) and the bright portion potential (Vl) deviate from target values to respectively be Vdm and Vlm.

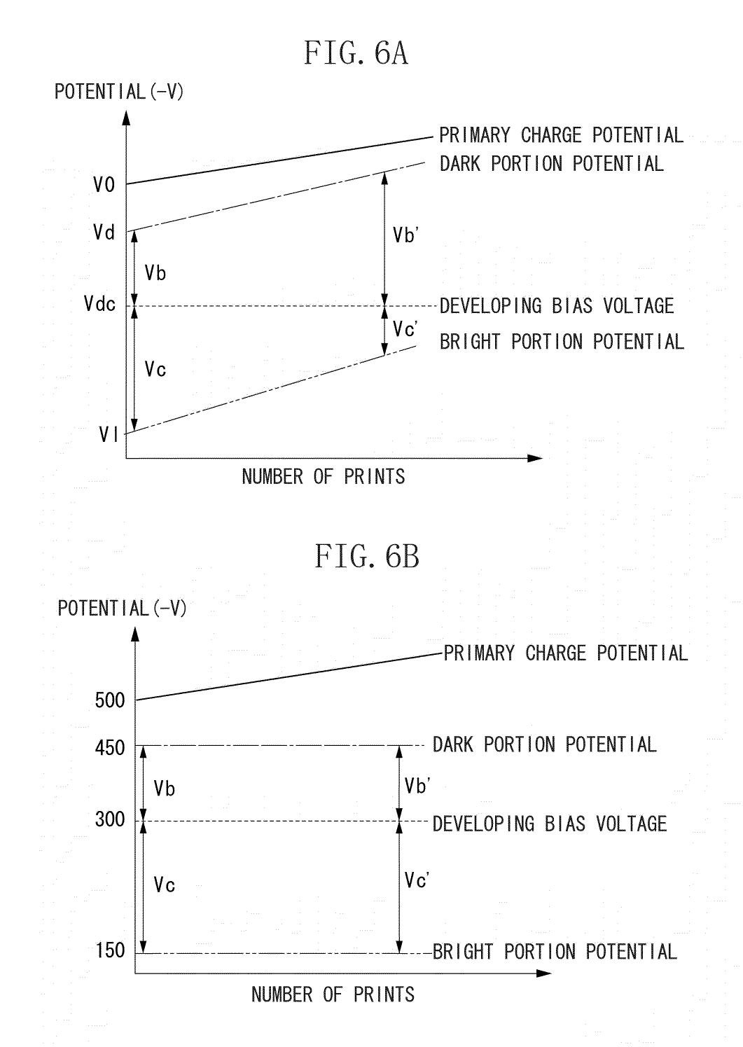

FIG. 6A schematically illustrates potential changes of Vd and Vl when the charging voltage is fixed, and the laser exposure output value is not changed according to use information of the photosensitive drum. The number of prints is used as a used amount of the photosensitive drum. As described above, because of the change of the E-V curve caused by the change in photosensitive layer film thickness, the dark portion potential (Vd) and the bright portion potential (Vl) increase. As a result, white portion contrast (Vb′) increases, and development contrast (Vc′) decreases, thereby reducing image quality such as an image density, fogging, a line width or gradation.

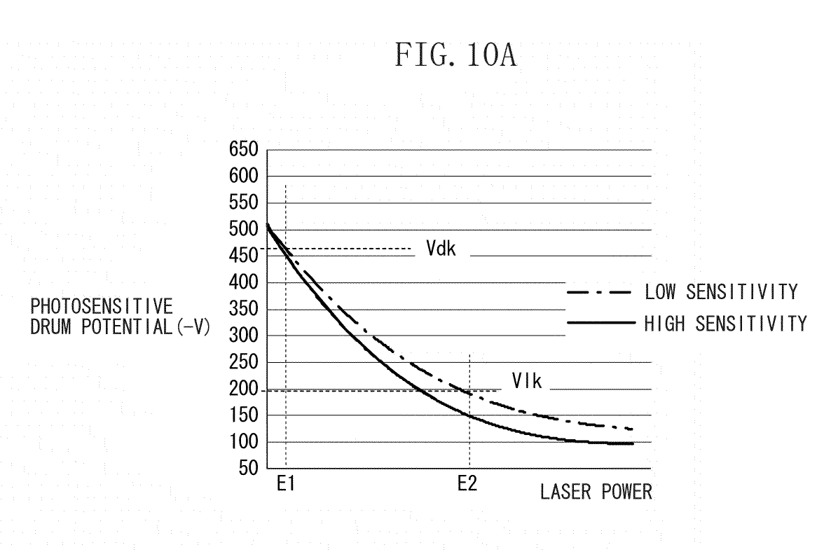

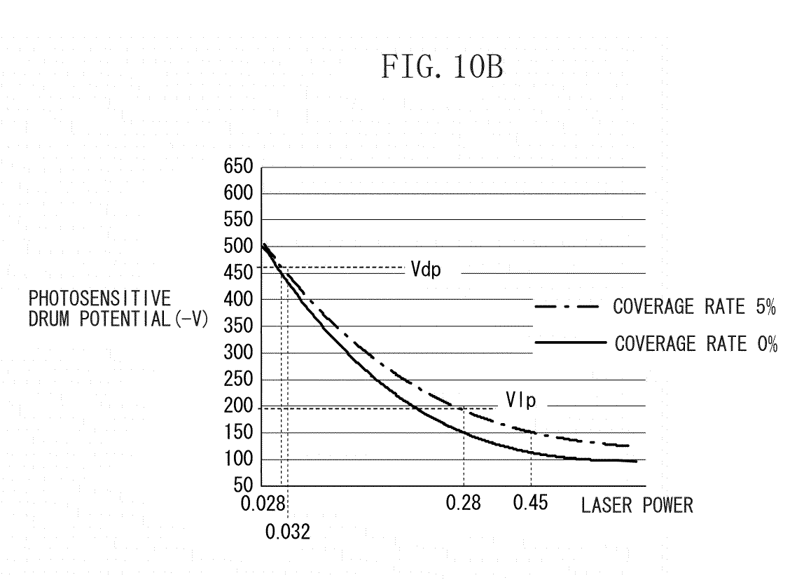

The E-V curve of the photosensitive drum is also changed by a sensitivity variation of the photosensitive layer. This is characteristics of each photosensitive drum, which is attributed to manufacturing conditions or materials. FIG. 10A illustrates E-V curves when the photosensitive drums having film thicknesses of 13 (μm) with different sensitivity levels are charged. As illustrated in FIG. 10A, the sensitivity of the photosensitive layer affects inclination of the E-V curve. As in the aforementioned case, when laser exposure output values E1 and E2 are set, assuming the photosensitive drums having high sensitivity, target dark portion and bright portion potentials (Vd and Vl) are not acquired for drums having low sensitivity. The potentials respectively become Vdk and Vlk.

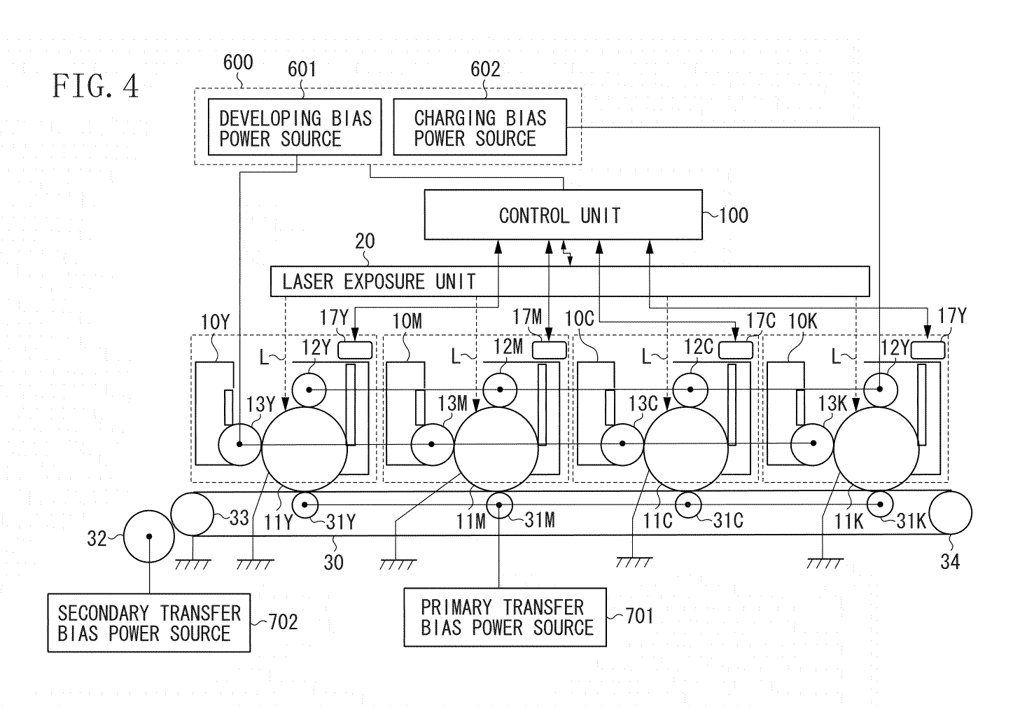

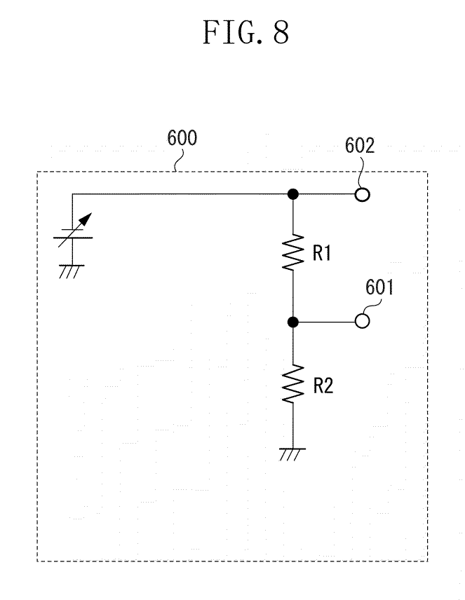

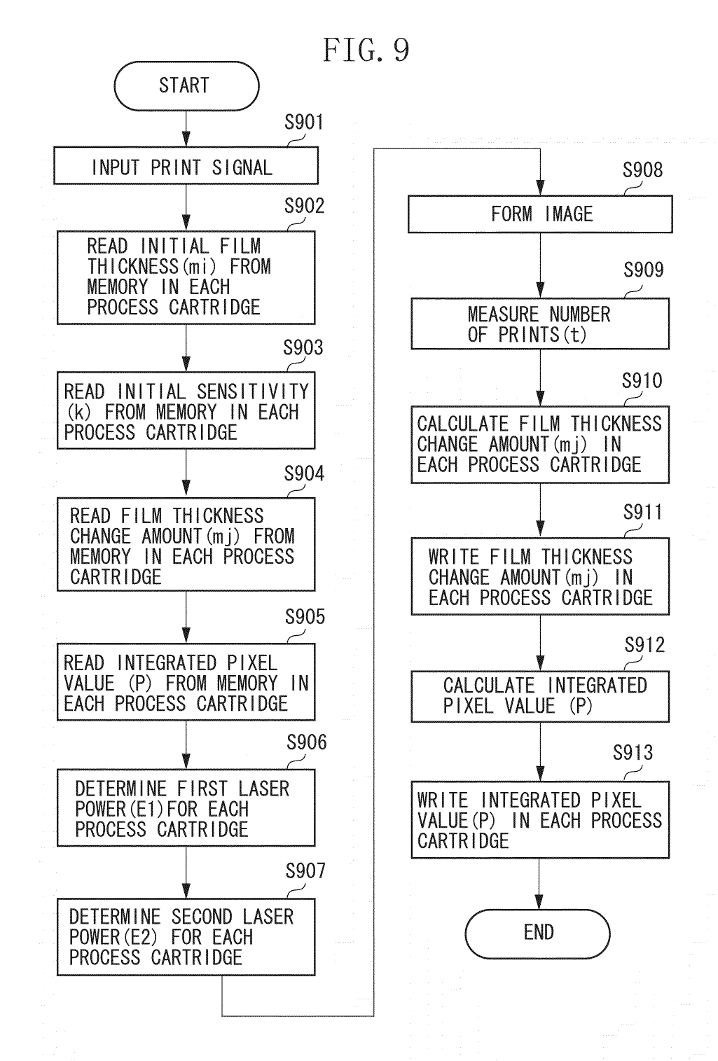

FIG. 4 is a wiring diagram illustrating connection between the charging bias power source and each of process cartridges, and the developing bias power source and each of process cartridges. As illustrated in FIG. 4, a common charging bias power source 602 is connected to the charging rollers 12Y, 12M, 12C, and 12K of the process cartridges 10Y, 10M, 10C, and 10K. Specifically, equal charging bias voltages are applied to the charging rollers 12Y, 12M, 12C, and 12K. Similarly, common developing bias power source 601 is connected to the developing rollers 13Y, 13M, 13C, and 13K of the process cartridges 10Y, 10M, 10C, and 10K. In this case, equal developing bias voltage values are also applied to the developing rollers 13Y, 13M, 13C, and 13K. Further, in the present exemplary embodiment, as illustrated in FIG. 8, the charging bias power source 602 and the developing bias power source 601 share a circuit to constitute a common power source 600. In other words, a difference between a DC voltage value of a charging bias voltage and a DC voltage value of a developing bias voltage is fixed.

Thus, in the image forming apparatus 1 according to the present exemplary embodiment, the power sources for the charging rollers 12Y, 12M, 12C,and 12K and the developing rollers 13Y, 13M, 13C, and 13K of the process cartridges 10Y, 10M, 10C, and 10K are shared as much as possible. The smaller number of power sources enables miniaturization of the apparatus and achievement of low costs.

In the present exemplary embodiment, the charging bias power source 602 and the developing bias power source 601 include resistance voltage-dividing circuits. However, a configuration where the difference between the DC voltage values is fixed by using a Zener diode element can be used. Further, an image forming apparatus in which DC bias voltages applied from the primary transfer bias power source to the respective primary transfer rollers are shared can also be applied to the present exemplary embodiment.

Next, a method for setting laser power of the non-image portion exposure amount (E1) and the image portion exposure amount (E2) according to the present exemplary embodiment will be described.

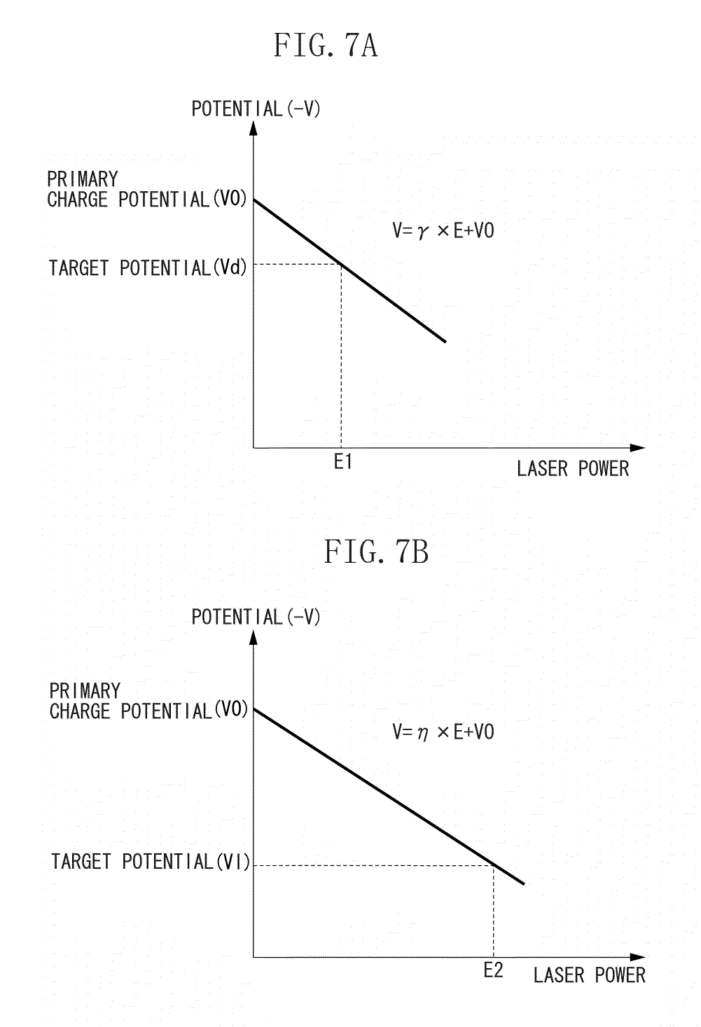

In the present exemplary embodiment, the E-V curve is accurately predicted from information about the film thickness of the photosensitive drum 11 at the time of manufacturing (initial film thickness) and use history of the photosensitive drum 11, and laser power is controlled to generate desired dark portion and bright portion potentials (Vd and Vl). Specifically, as illustrated in FIGS. 7A and 7B, real use regions of the E-V curve of the photosensitive drum are approximated by linear functions different in inclination. FIG. 7A illustrates approximation of the E-V curve by a linear function near the dark portion potential (Vd). FIG. 7B illustrates approximation of the E-V curve by a linear function near the bright portion potential (Vl). Laser power E1 and laser power E2 necessary for respectively acquiring target dark portion and bright portion potentials Vd=−450 (V) and Vl=−150 (V) are calculated. The control unit 100 reads information mi (μm) about initial film thickness, information mj (μm) about a film thickness change amount, and information k1 and k2 about initial photosensitive layer sensitivity from the memory 17, where information k1 is about sensitivity near the dark portion potential (Vd), and information k2 is about sensitivity near the bright portion potential (Vl). Then, for each process cartridge, laser power E1 and laser power E2 are calculated by using the following formulas (1) to (6):

E1=k1×(Vd−V0)/γ (1)

E2=k2×(Vl−V0)/η (2)

V0=Vp−α×(mi−mj)+δ (3)

γ=ω×(mi−mj)+τ (4)

η=μ×γ (5)

mj=ε×t (6)

α, δ, ω, τ, μ, and ε: coefficients

The information k1 and k2 about the initial film thickness mi ((μm) and the initial photosensitive layer sensitivity are written in the memory 17 at the time of manufacturing. The information about the film thickness change amount mj (μm) calculated from the number of prints t is written in the memory 17 as needed. A value of the charging bias voltage (Vp) is fixed irrespective of use of the photosensitive drum, and Vp is set to 1040. In the present exemplary embodiment, the formulas (1) to (6) are linear functions, which are appropriately determined according to characteristics of the photosensitive drum and the image forming apparatus. They can be polynomial expressions or include a plurality of curves. In the present exemplary embodiment, the film thickness of the photosensitive drum, the charging voltage, and the primary charging voltage are correlated by empirically calculating a relationship beforehand. The formulas are in no limitative. Concerning the calculation of the film thickness change amount of the photosensitive layer, in addition to the number of prints, one of a period of voltage application to the charging unit and a rotational period of the photosensitive drum can be selected or a combination thereof can be used. Further, the coefficients α, δ, ω, τ, μ, and ε are arbitrarily optimized according to the characteristics of the photosensitive drum and the image forming apparatus. If the image forming apparatus includes a sensor configured to detect an atmosphere state such as a temperature or a humidity where the image forming apparatus is used, the coefficients are corrected according to the detected atmosphere state, thereby enabling more specific control. In the present exemplary embodiment, information k1=1 and k2=1 about the photosensitive drum sensitivity and coefficients α=10, β=860, δ=−360, ω=−80, τ=−700, μ=0.7, and ε=5×10−4 are used. In the present exemplary embodiment, while the calculation is executed with k1 and k2 each set to 1, sensitivity near the dark portion potential and sensitivity near the bright portion potential may differ depending on materials of the photosensitive drum. In such a case, by appropriately setting the sensitivity coefficients k1 and k2, the laser power E1 and the laser power E2 can be more accurately controlled.

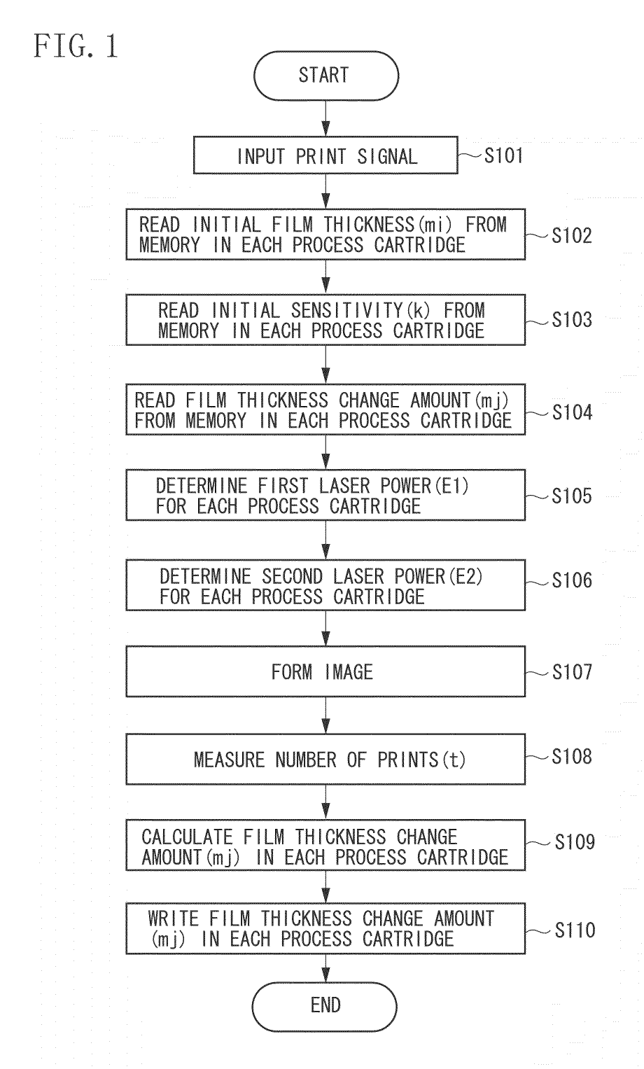

Next, referring to the flowchart of FIG. 1, the laser power control method according to the present exemplary embodiment will be described. In step S101, a print signal is input from the printer controller 200. The communication unit 101 in the image forming apparatus 1 communicates with the memories 17Y, 17M, 17C, and 17K mounted on the process cartridges 10Y, 10M, 10C, and 10K. Then, in steps S102 to S104, the control unit 100 reads an initial film thickness mi, initial sensitivities k1 and k2, and a film thickness change amount mj stored in the memories.

Next, in step S105, the control unit 100 determines first laser power E1 for each process cartridge based on the formulas (1) to (6). In step S106, the control unit 100 similarly determines second laser power E2. In step S107, the control unit 100 executes an image forming operation. In step S108, the control unit 100 counts the number of prints t. In step S109, the control unit 100 calculates the film thickness change amount mj from the counting result based on the formula (6). In step S110, the control unit 100 writes the calculation result in the memory 17 for each process cartridge via the communication unit 101.

As an example of the control, the photosensitive drum of an initial photosensitive layer film thickness of 8 (μm) was used.

In the image forming apparatus, print testing for 10000 sheets was conducted. As a result, since the film thickness change amount of the photosensitive drum was 5 (μm), the photosensitive layer film thickness was 13 (μm). FIG. 5B illustrates E-V curves when charging voltages Vp=1040 (V) are applied to the photosensitive drums of photosensitive layer film thicknesses of 18 (μm) and 13 (μm).

In this case, the control unit 100 was able to generate the dark portion potential Vd=−450 (V) and the bright portion potential Vl=−150 (V) by reading the film thickness information from the memory 17 and respectively setting laser output values to E1=0.05 (μJ/cm²) and E2=0.32 (μJ/cm²). FIG. 6B illustrates a potential change during the print testing. A stable potential setting was maintained over a long period of use of the photosensitive drum by calculating the photosensitive layer film thickness according to the number of prints and controlling the laser power output values E1 and E2.

In the present exemplary embodiment, the laser power is defined as an exposure amount received by the photosensitive drum surface driven to rotate at a surface speed of 120 (mm/sec.). To acquire each exposure amount, the control unit 100 controls the laser output value.

An image forming apparatus, a photosensitive drum, a latent image setting, and a high-voltage power source according to a second exemplary embodiment are similar in configuration to those of the first exemplary embodiment. The present exemplary embodiment includes a feature that prediction accuracy in the E-V curve is further improved by taking into consideration exposure history of the photosensitive drum to control laser power E1 and laser power E2.

A factor of a potential change accompanying use of the photosensitive drum includes, in addition to a change in photosensitive layer film thickness, a (reduction) change in sensitivity due to laser exposure. The sensitivity change is caused by repeated image portion exposure by relatively large laser exposure power, which accumulates residual charges in the photosensitive layer. Thus, the degree of the sensitivity change varies depending on a laser exposure area, namely, the number of image data. As accumulated exposure energy is greater, a residual charge amount increases. As an example, FIG. 10B illustrates the E-V curve of a photosensitive drum of 13 (μm) after printing 10000 sheets of an A4-size image with a coverage rate of 0% and with a coverage rate of 5%. The E-V curve changes based on history (exposure history) of print image data. When laser exposure output values E1=0.028 (μJ/cm²) and E2=0.28 (μJ/cm²) are set, assuming a photosensitive drum of no exposure history, target dark portion bright portion potentials (Vd and Vl) are not acquired for drums having exposure history. They respectively become Vdp and Vlp.

In the present exemplary embodiment, exposure history ρ of the photosensitive drum of each process cartridge is detected. Specifically, the control unit 100 counts the number of pixels from the print image data, and calculates an integrated pixel value P to acquire exposure history ρ. For example, when an A4-size image is printed on 10 sheets with a coverage rate of 5%, an integrated pixel value P is counted as P=50. The integrated pixel value P is written in the memory 17 at every printing.

The control unit 100 reads information mi (μm) about initial film thickness, information mj (μm) about a film thickness change amount, information k1 and k2 about initial photosensitive layer sensitivity, and the integrated pixel value P from memories 17Y, 17M, 17C, and 17K. Then, the control unit 100 calculates laser power E1 and laser power E2 (μJ/cm²) necessary for acquiring dark portion potential Vd=−450 (V) and bright portion potential Vl=−150 (V) by using formulas (3) to (6) and the following formulas (8) to (10). For a charging voltage Vp, in the present exemplary embodiment, Vp=−990 (V) was used.

E1=λ×ρ×k1×(Vd−V0)/γ (8)

E2=ρ×k2×(Vd−V0)/η (9)

ρ=ξ×P (10)

λ and ξ: coefficients

In the present exemplary embodiment, coefficients of λ=0.7 and ξ=3.2×10−5 were used. As in the case of the first exemplary embodiment, information k1=1 and k2=1 about the photosensitive drum sensitivity and coefficients α=10, β=860, δ=−360, ω=−80, τ=−700, μ=0.7, and ε=5×10−4 were used.

Formulas and coefficients are appropriately determined according to characteristics of the photosensitive drum and the image forming apparatus, and thus not limited to the aforementioned formulas or coefficients.

Next, referring to the flowchart of FIG. 9, the laser power control method according to the present exemplary embodiment will be described. In step S901, a print signal is input from the printer controller (external host apparatus) 200. The communication unit 101 in the image forming apparatus 1 communicates with the memories 17Y, 17M, 17C, and 17K mounted on the process cartridges 10Y, 10M, 10C, and 10K. Then, insteps S902 to S905, the control unit 100 reads an initial film thickness mi, initial sensitivities k1 and k2, a film thickness change amount mj, and the integrated pixel value P stored in the memories. Then, in step S906, the control unit 100 determines first laser power E1 for each process cartridge based on the formulas (3) to (6) and the formulas (8) to (10). In step S907, the control unit 100 similarly determines second laser power E2. In step S908, the control unit 100 executes an image forming operation. In step S909, the control unit 100 counts the number of prints t. In step S910, the control unit 100 calculates the film thickness change amount mj from the counting result based on the formula (6). In step S911, the control unit 100 writes the calculation result in the memory 17 of each process cartridge via the communication unit 101. In step S912, the control unit 100 counts the number of pixels based on the image data converted by the image processing unit 103. In step S913, the control unit 100 writes (overwrites) the counting result as an integrated pixel value P via the communication unit 101.

As an example of the control, the photosensitive drum of an initial photosensitive layer film thickness of 8 (μm) was used to print 10000 sheets of an A4-image with a coverage rate of 5%. E-V curves of the photosensitive drum after the printing are as illustrated in FIG. 10B. The control unit 100 was able to generate dark portion potential Vd=−450 (V) and bright portion potential Vl=−150 (V) by respectively setting laser output values to E1=0.032 (μJ/cm²) and E2=0.45 (μJ/cm²) for a photosensitive drum having its film thickness, which has been changed to 13 (μm). As a result, good images were acquired over a long period of use. In the second exemplary embodiment, as in the case of the first exemplary embodiment, a power source circuit of a charging voltage and a developing voltage can be shared among the process cartridges, and thus an image forming apparatus, which is excellent in miniaturization and cost can be provided.

The present invention is not limited to the color image forming apparatus. The invention is applicable even to a single process cartridge because similar effects can be provided. The laser power E1 and the laser power E2 are applicable even in the case of exposure amounts of two levels formed by changing emission time through pulse width modulation. Further, the light source is not limited to the laser diode. The light source can be a light-emitting diode.

In the exemplary embodiments, a bias applied to the charging unit is a DC voltage including only a DC component. This is because an image failure occurs more easily due to non-uniform charging in the charging method (DC charging method) based on the DC voltage. However, the present invention is not limited to the DC charging. For example, the present invention can be applied to an image forming apparatus even employing an AC charging method for executing charging by superposing an AC voltage on a DC voltage, as long as the apparatus is configured to expose a non-image portion and an image portion to generate potentials.

While the present disclosure has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-264879 filed Dec. 2, 2011, which is hereby incorporated by reference herein in its entirety.

What is claimed is:

1. An image forming apparatus configured to form an image on a recording medium, the image forming apparatus comprising:
a photosensitive member;
a charging unit configured to charge the photosensitive member;
an exposure unit configured to expose the photosensitive member charged by the charging unit with first laser power to generate a non-image portion potential in a non-image portion of the photosensitive member and with second laser power different from the first laser power to generate an image portion potential in an image portion of the photosensitive member;
a development unit configured to form a developer image by applying a developer to a portion of the image portion potential;
a control unit configured to control the laser power of the exposure unit; and
a storage unit configured to store information about the photosensitive member obtained when the photosensitive member is brand-new,
wherein the control unit is configured to change an output of the first laser power according to the information about the photosensitive member obtained when the photosensitive member is brand-new, stored in the storage unit.

2. The image forming apparatus according to claim 1, wherein the control unit is configured to change an output of the second laser power according to the information about the photosensitive member obtained when the photosensitive member is brand-new, stored in the storage unit.

3. The image forming apparatus according to claim 2, wherein the control unit is configured to change the outputs of the first laser power and the second laser power according to the information about the photosensitive member obtained when the photosensitive member is brand-new, stored in the storage unit, and information about the photosensitive member changed through use thereof.

4. The image forming apparatus according to claim 1, wherein the information about the photosensitive member obtained when the photosensitive member is brand-new includes at least one of information about an initial photosensitive layer film thickness of the photosensitive member and information about initial sensitivity of the photosensitive member.

5. The image forming apparatus according to claim 3, wherein the outputs of the first laser power and the second laser power are controlled by using different formulas.

6. The image forming apparatus according to claim 3, wherein the information about the photosensitive member changed through use thereof includes information about a photosensitive layer film thickness of the photosensitive member.

7. The image forming apparatus according to claim 6, wherein the information about the photosensitive layer film thickness is calculated based on at least one of a rotational period of the photosensitive member and a voltage application period to the charging unit.

8. The image forming apparatus according to claim 3, wherein the information about the photosensitive member changed through use thereof includes information about sensitivity of the photosensitive member.

9. The image forming apparatus according to claim 8, wherein the information about the sensitivity of the photosensitive member is calculated based on information about an exposure amount of exposing a surface of the photosensitive member by the exposure unit.

10. The image forming apparatus according to claim 9, wherein the information about the exposure amount is calculated based on a pixel value for image formation.

11. The image forming apparatus according to claim 1, wherein at least one of the development unit, the charging unit, and a cleaning unit configured to clean the photosensitive member is formed integrally with the photosensitive member to constitute a process cartridge detachably attached to the image forming apparatus.

12. The image forming apparatus according to claim 1, wherein at least one of the development unit, the charging unit, and a cleaning unit configured to clean the photosensitive member is formed integrally with the photosensitive member and the storage unit to constitute a process cartridge detachably attached to the image forming apparatus.

13. The image forming apparatus according to claim 1, further comprising:
a circuit configured to keep a predetermined difference between a DC voltage value applied to the charging unit and a DC voltage value applied to the development unit.

14. The image forming apparatus according to claim 3, wherein the storage unit is configured to read and write information and to store the information about the photosensitive member changed through use thereof

15. The image forming apparatus according to claim 3, wherein the control unit is configured to increase the outputs of the first laser power and the second laser power as the use of the photosensitive member progresses.

16. The image forming apparatus according to claim 15, wherein, when the control unit increases the outputs of the first laser power and the second laser power as the use of the photosensitive member progresses, an increase amount of the second laser power is larger than that of the first laser power.

17. The image forming apparatus according to claim 1, wherein a voltage including only a DC component is applied to the charging unit, and a size of the voltage is constant.

18. The image forming apparatus according to claim 1, wherein the image forming apparatus includes a plurality of the photosensitive members, a plurality of the charging units, and a plurality of the development units, and is configured to be capable of forming a color image,
wherein a voltage is applied to the plurality of the charging units from a common power source, and
wherein a voltage is applied to the plurality of the development units from a common power source.

19. The image forming apparatus according to claim 3, wherein the image forming apparatus includes a plurality of the photosensitive members, a plurality of the charging units, and a plurality of the development units, and is configured to be capable of forming a color image,
wherein a voltage is applied to the plurality of the charging units from a common power source,
wherein a voltage is applied to the plurality of the development units from a common power source, and
wherein the control unit is configured to individually control the first laser power and the second laser power for respective photosensitive members when exposing the plurality of the photosensitive members.

20. The image forming apparatus according to claim 1, wherein the charging unit includes a roller configured to contact the photosensitive member.
